(19) United States
(12) Patent Application Publication
(10) Pub. No.: US 2024/0068504 A1
(43) Pub. Date: Feb. 29, 2024

(54) LOCKING DEVICE

(71) Applicant: FAITH INDUSTRY (T) CO., LTD., Taoyuan City (TW)

(72) Inventor: YU-LANG WU, Taoyuan City (TW)

(21) Appl. No.: 17/894,182

(22) Filed: Aug. 24, 2022

(51) Int. Cl. F16B 39/10; F16B 39/282

(52) U.S. Cl. CPC F16B 39/10; F16B 39/282

(57) ABSTRACT

A locking device includes a locking mechanism and a joint mechanism movably combined thereto. The joint mechanism includes a positioning sleeve, a joint sleeve and a joint spring. The positioning sleeve has a first stop convex part and a second stop convex part. A part of the joint sleeve is sleeved in the positioning sleeve, and respectively extends a fastening part and a third stop convex part. The joint spring butts between the first stop convex part and the third stop convex part, so that the third stop convex part is attached to the second stop convex part. The joint sleeve is configured to be rotated so that the third stop convex part is out of the state of being stopped by the second stop convex part to draw the fastening part closer to the first opening.

### BACKGROUND OF THE INVENTION

### 1. Field of the Invention

The present disclosure provides a locking device, specifically a locking device that does not need to be riveted or welded to workpieces.

### 2. Description of the Related Art

A locking device used to lock two workpieces usually requires a main body of the locking device to be riveted or welded to a first workpiece, and then the locking piece in the locking device is locked through the two workpieces. Whether it is riveting or welding, there are complicated processes and problems that cannot be restored.

### BRIEF SUMMARY OF THE INVENTION

The inventor exhausted his mind and carefully researched to develop a locking device to quickly lock two workpieces without the need for welding or riveting.

The present disclosure provides a locking device, including: a locking mechanism and a joint mechanism. The joint mechanism may be movably combined to the locking mechanism. The joint mechanism includes a positioning sleeve. The positioning sleeve has a first opening and has a first stop convex part near the first opening on an inner side wall and a second stop convex part separated from the first stop convex part. The joint mechanism further includes a joint sleeve. The joint sleeve includes a barrel, a fastening part and a third stop convex part. A part of the barrel is sleeved in the positioning sleeve, the fastening part extends from one end of the barrel and is located outside the first opening, the third stop convex part extends from another end of the barrel and is located between the first stop convex part and the second stop convex part. The joint mechanism further includes a joint spring. The joint spring surrounds the barrel and butts between the first stop convex part and the third stop convex part, so that the third stop convex part is attached to the second stop convex part. The joint sleeve is configured to be rotated so that the third stop convex part is out of the state of being stopped by the second stop convex part, and crosses over the second stop convex part by an elastic force of the joint spring, whereby the fastening part is drawn closer to the first opening.

In one embodiment, the positioning sleeve further includes a fourth stop convex part, the second stop convex part is located between the first stop convex part and the fourth stop convex part, the fourth stop convex part is configured to restrict a movement limit of the third stop convex part after the third stop convex part crosses over the second stop convex part.

In one embodiment, an outer periphery of the fastening part is a non-circular surrounding shape.

In one embodiment, the outer periphery of the fastening part has two sides parallel to each other, the outer periphery as a whole of the fastening part is polygonal.

In one embodiment, an outer periphery of the third stop convex part has two opposite recesses, three recesses uniformly distributed around the outer periphery, or four recesses uniformly distributed around the outer periphery.

In one embodiment, the positioning sleeve has a placement part corresponding to a shape of the fastening part at an outer periphery of the first opening.

In one embodiment, the positioning sleeve further includes a fourth stop convex part, the second stop convex part is located between the first stop convex part and the fourth stop convex part, the locking mechanism include an operating barrel, a locking piece and a locking spring. The operating barrel has a sleeve part enclosing outside the positioning sleeve and a cap part that is connected to the sleeve part and relative to the fourth stop convex part, the sleeve part and the cap part also define a motion space for a telescopic motion of the positioning sleeve. The locking piece is fixedly connected to the cap part and extends out of a second opening of the joint sleeve. The locking spring is located in the motion space and surrounds the locking piece, the locking spring abuts between the fourth stop convex part and the cap part.

In one embodiment, the locking piece has an external thread, the operating barrel is configured to rotate relative to the positioning sleeve.

In one embodiment, the locking mechanism further includes a cap casing piece, the cap casing piece encloses and fixes to the outside of the sleeve part. The cap casing piece has a texture for easy to hold.

In one embodiment, an elastic force of the joint spring is greater than an elastic force of the locking spring.

Accordingly, the locking device of the embodiment of the present disclosure may first clamp a substrate workpiece between the fastening part and the first opening by a joint mechanism, so that there is no need to be welded or riveted. Further, the locking device may also be dismantled from the substrate workpiece by reverse operation for reuse.

### BRIEF DESCRIPTION OF THE DRAWINGS

FIG. 1 is a schematic sectional view of a locking device according to an embodiment of the present disclosure.

FIG. 2 is a schematic outside perspective view corresponding to FIG. 1.

FIG. 3 is a schematic side view 1 of a joint sleeve according to an embodiment of the present disclosure.

FIG. 4 is a schematic side view 2 of the joint sleeve according to the embodiment of the present disclosure.

FIG. 5 is a schematic side view 3 of the joint sleeve according to the embodiment of the present disclosure.

FIG. 6 is a schematic side view corresponding to FIG. 3 at a side of a third stop convex part.

FIG. 7 is a schematic side view corresponding to FIG. 4 at the side of the third stop convex part.

FIG. 8 is a schematic side view corresponding to FIG. 5 at the side of the third stop convex part.

FIG. 9 is a schematic sectional view of a locking device according to another embodiment of the present disclosure.

FIG. 10 is a schematic outside perspective view of a locking device according to still another embodiment of the present disclosure.

FIG. 11 is a schematic outside perspective view of a locking device according to further another embodiment of the present disclosure.

### DETAILED DESCRIPTION OF THE INVETION

The aforementioned and other technical contents, characteristics and effects of the present disclosure can be clearly presented by the detailed description of preferable embodiments together with the attached drawings. It's worth mentioning that the direction terms mentioned in the following embodiments, such as: top, bottom, left, right, front or back, etc., are only referred to the direction of the drawings. Therefore, the directional terms used are intended to illustrate, not to limit the disclosure.

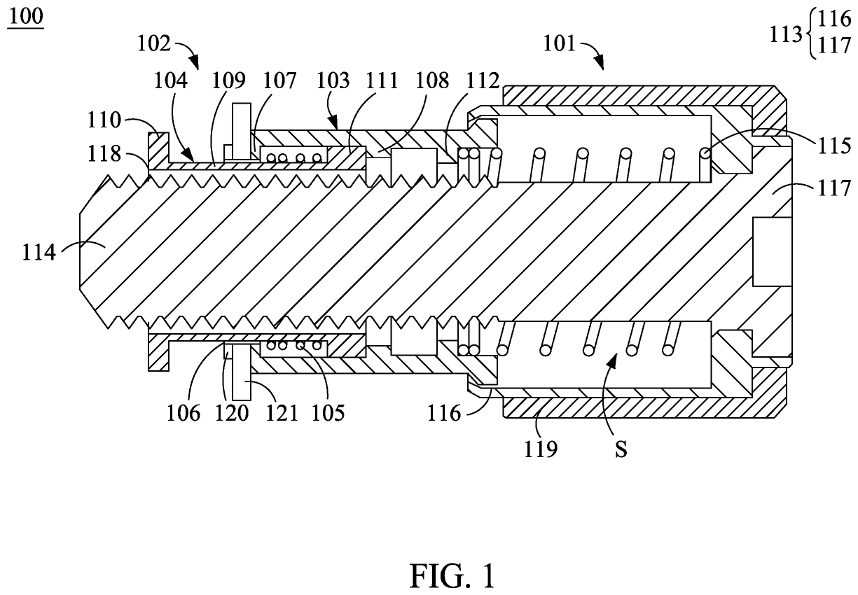

Referring to FIG. 1, an embodiment of the present disclosure provides a locking device 100, which includes a locking mechanism 101 and a joint mechanism 102. The joint mechanism 102 may be movably combined to the locking mechanism 101. The joint mechanism 102 includes a positioning sleeve 103, a joint sleeve 104, and a joint spring 105. The positioning sleeve 103 has a first opening 106 and has a first stop convex part 107 near the first opening 106 on an inner side wall and a second stop convex part 108 separated from the first stop convex part 107. The joint sleeve 104 includes a barrel 109, a fastening part 110 and a third stop convex part 111. A part of the barrel 109 is sleeved in the positioning sleeve 103, the fastening part 110 extends from one end of the barrel 109 and is located outside the first opening 106. The third stop convex part 111 extends from another end of the barrel 109 and is located between the first stop convex part 107 and the second stop convex part 108. The joint spring 105 butts between the first stop convex part 107 and the third stop convex part 111, so that the third stop convex part 111 is attached to the second stop convex part 108. The joint sleeve 104 is configured to be rotated so that the third stop convex part 111 is out of the state of being stopped by the second stop convex part 108, and crosses over the second stop convex part 108 by an elastic force of the joint spring 105, whereby the fastening part 110 is drawn closer to the first opening 106.

As described above, the locking device 100 of the embodiment of the present disclosure may first clamp a substrate workpiece (not shown) between the fastening part 110 and the first opening 106 by a joint mechanism 102, so that there is no need to be welded or riveted. Further, the locking device 100 may also be dismantled from the substrate workpiece by reverse operation for reuse.

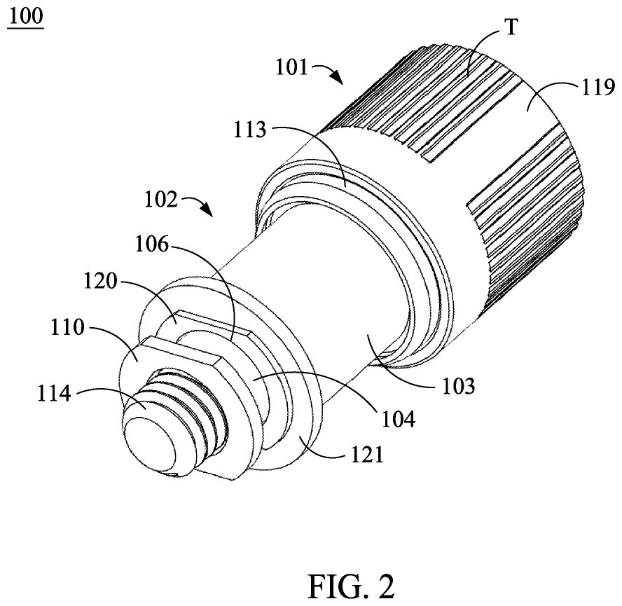

As shown in FIGS. 1 and 2, in one embodiment, the positioning sleeve 103 may further include a fourth stop convex part 112, the second stop convex part 108 is located between the first stop convex part 107 and the fourth stop convex part 112, the fourth stop convex part 112 is configured to restrict a movement limit of the third stop convex part 111 after the third stop convex part 111 crosses over the second stop convex part 108. The locking mechanism 101 may include an operating barrel 113, a locking piece 114 and a locking spring 115. The operating barrel 113 has a sleeve part 116 enclosing outside the positioning sleeve 103 and a cap part 117 that is connected to the sleeve part 116 and relative to the fourth stop convex part 112. The sleeve part 116 and the cap part 117 also define a motion space S for a telescopic motion of the positioning sleeve 103. The locking piece 114 is fixedly connected to the cap part 117 and extends out of a second opening 118 of the joint sleeve 104. An inner edge of one end of the sleeve part 116 and an outer edge of one end of the positioning sleeve 103 may be respectively bent, so that the operating barrel 113 and the positioning sleeve 103 remain movable but not disengaged.

As shown in FIGS. 1 and 2, in one embodiment, the locking spring 115 is located in the motion space S and surrounds the locking piece 114. The locking spring 115 abuts between the fourth stop convex part 112 and the cap part 117. After the joint mechanism 102 is engaged with the substrate workpiece, the locking mechanism 101 may be used to lock a workpiece to be locked (not shown) to the substrate workpiece. The locking piece 114 may have an external thread, the operating barrel 113 is configured to rotate relative to the positioning sleeve 103, in order to lock the workpiece to be locked by screwing, but not limited thereto, the locking mechanism 101 may also be other forms, such as pressing fastening and the like. The locking mechanism 101 may further comprise a cap casing piece 119. The cap casing piece 119 encloses and fixes to the outside of the sleeve part 116, and the surface has a texture T for easy to hold, in order to facilitate turning of users for operation. An elastic force of the joint spring 105 may be greater than that of the locking spring 115, so when the locking mechanism 101 is locked, the elastic force applied to the joint mechanism 102 by the locking spring 115 has no effect on the joint spring 105, and the joint mechanism 102 may still be fastened to the substrate workpiece.

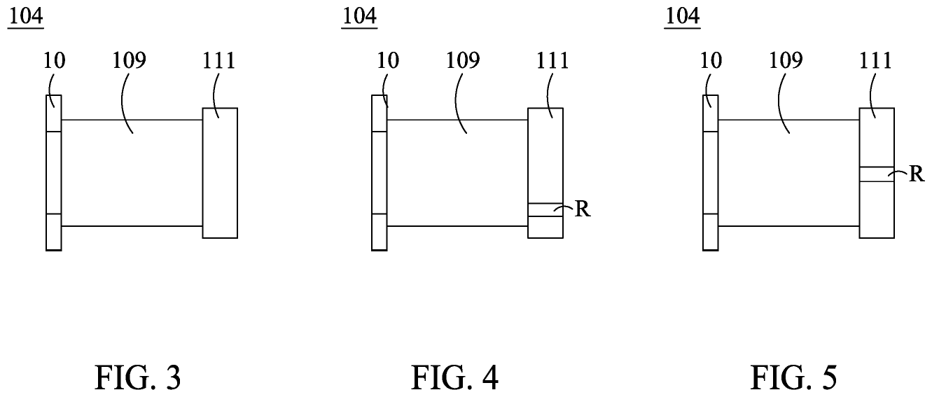

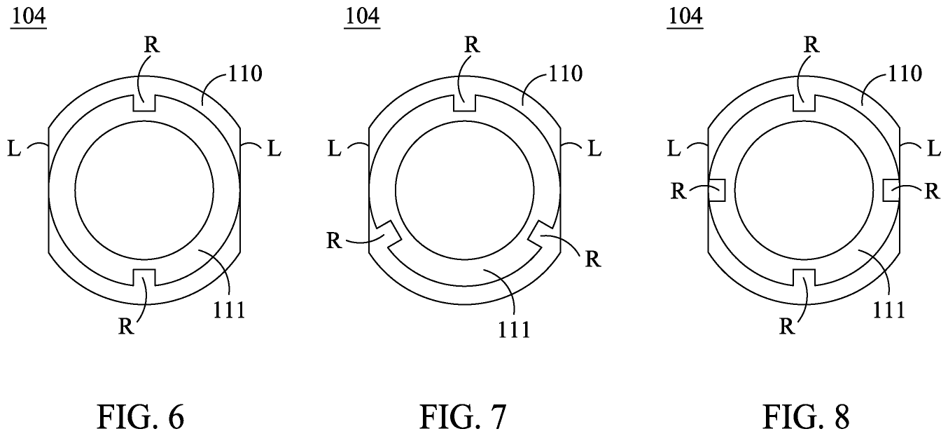

As shown in FIGS. 3 to 8 and with reference to FIGS. 1 and 2, in one embodiment, an outer periphery of the fastening part 110 may be a non-circular surrounding shape. The positioning sleeve 103 may have, for example, a placement part 120 of a convex step corresponding to a shape of the fastening part 110 at an outer periphery of the first opening 106 (as shown in FIG. 2). The outer periphery of the fastening part 110 may have two sides L parallel to each other. The substrate workpiece may have an open port (not shown) corresponding to a shape of the outer perimeter of the fastening part 110. The fastening part 110 may entirely pass through the open port, the placement part 120 may be placed in the open port, so that the joint mechanism 102 as a whole is not rotatable relative to the substrate workpiece. The positioning sleeve 103 may be further provided with a stop plate 121 (as shown in FIGS. 1 and 2) to correspond to a pore edge of the open pore of the substrate workpiece for stopping. When the fastening part 110 is rotated and misaligned with the open pore and pulled back by the joint spring 105 at the same time, the substrate workpiece may be fastened. In contrast, an outer periphery of the third stop convex part 111 may have two opposite recesses R (FIGS. 3 and 6), three recesses R uniformly distributed around the outer periphery (FIGS. 4 and 7), or four recesses R uniformly distributed around the outer periphery (FIGS. 5 and 8). The recesses R may be line patterns formed by processing. An open pore surrounded by the second stop convex part 108 may be a structure corresponding to the outer periphery of the third stop convex part 111, but is misaligned before joint, in order to be stopped by the second stop convex part 108, when rotated to the corresponding position, the elastic force of the joint spring 105 is released to push and abut the third stop convex part 111, so that the third stop convex part 111 crosses over the second stop convex part 108.

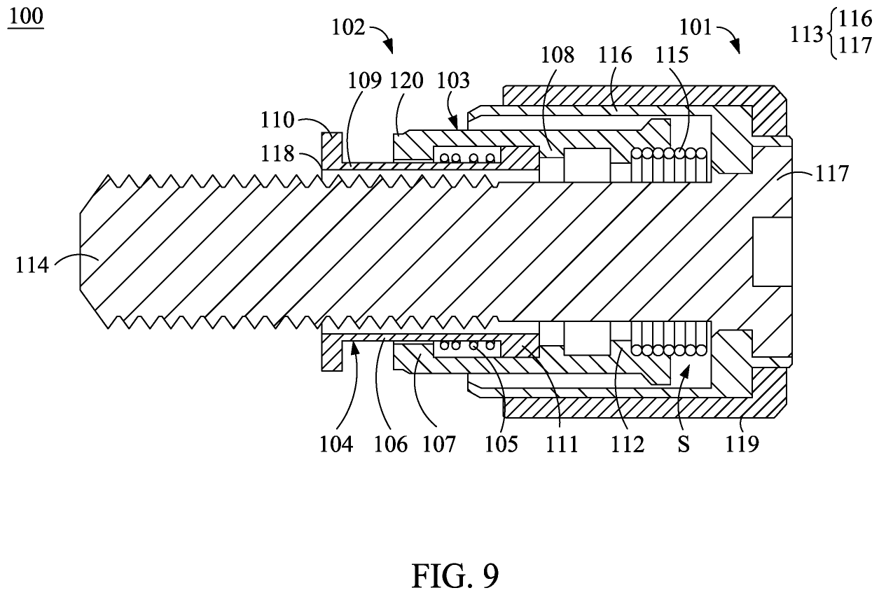

As shown in FIG. 9, an embodiment of FIG. 9 is substantially the same as the embodiment of FIGS. 1 and 2. The difference is only in the absence of the stop plate 121 provided by FIG. 1 and FIG. 2, and the stop is carried out by the convex step formed between the placement part 120 and the positioning sleeve 103 and the pore edge of the open pore of the substrate workpiece. Compared to FIGS. 1 and 2, FIG. 9 shows that the locking piece 114 has a longer part extending out of the second opening 118 because of the actuation. The same part as the foregoing embodiment is no longer repeated.

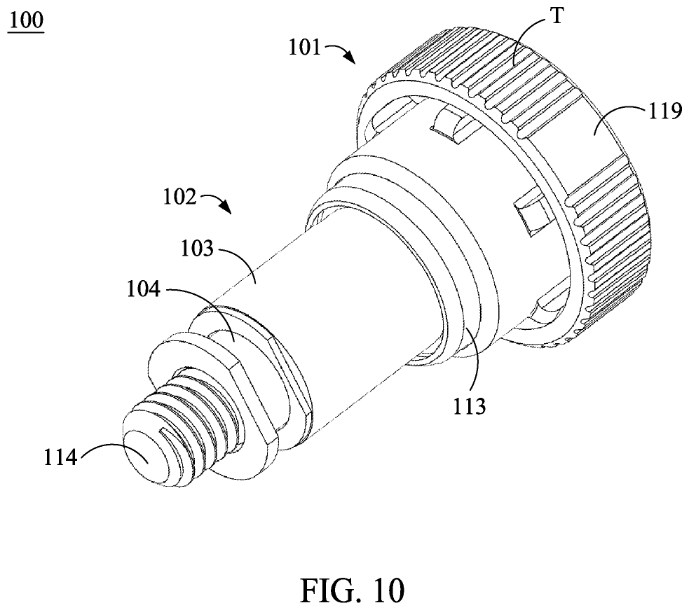

Referring to FIG. 10, FIG. 10 shows a locking device 100 according to another embodiment of the present disclosure. The present embodiment is substantially the same as the embodiment of FIGS. 1 and 2, the difference is mainly that the cap casing piece 119 has a narrower area of the texture T. The same part as the foregoing embodiment is no longer repeated.

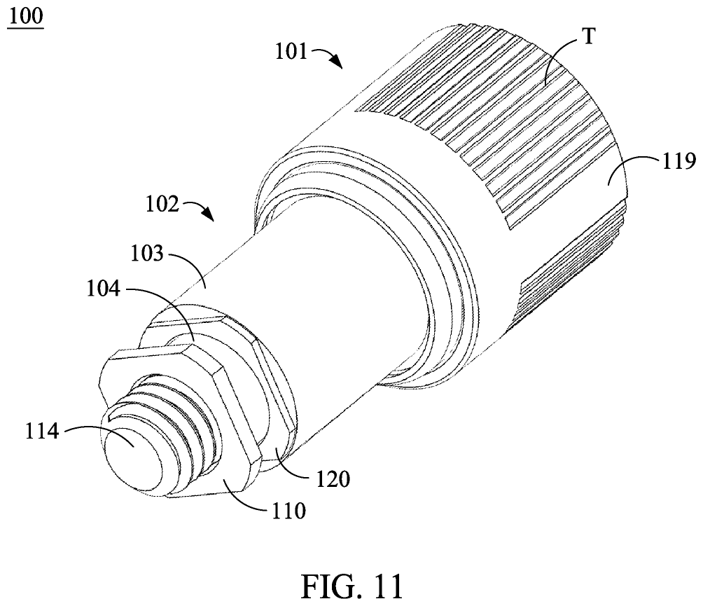

Referring to FIG. 11, FIG. 11 shows a locking device 100 according to still another embodiment of the present disclosure. The present embodiment is substantially the same as the embodiment of FIGS. 1 and 2, the difference is mainly that the outer peripheries as a whole of the fastening part 110 and the placement part 120 are polygonal. The same part as the foregoing embodiment is no longer repeated.

While the present disclosure has been described by means of preferable embodiments, those skilled in the art should understand the above description is merely embodiments of the disclosure, and it should not be considered to limit the scope of the disclosure. It should be noted that all changes and substitutions which come within the meaning and range of equivalency of the embodiments are intended to be embraced in the scope of the disclosure. Therefore, the scope of the disclosure is defined by the claims.

What is claimed is:

1. A locking device, comprising:
a locking mechanism; and
a joint mechanism, movably combined to the locking mechanism, and including:
a positioning sleeve, having a first opening and having a first stop convex part near the first opening on an inner side wall and a second stop convex part separated from the first stop convex part;
a joint sleeve, including a barrel, a fastening part and a third stop convex part, a part of the barrel is sleeved in the positioning sleeve, the fastening part extends from one end of the barrel and is located outside the first opening, the third stop convex part extends from another end of the barrel and is located between the first stop convex part and the second stop convex part; and
a joint spring, surrounding the barrel and butting between the first stop convex part and the third stop convex part, so that the third stop convex part is attached to the second stop convex part, the joint sleeve is configured to be rotated so that the third stop convex part is out of the state of being stopped by the second stop convex part, and crosses over the second stop convex part by an elastic force of the joint spring, whereby the fastening part is drawn closer to the first opening.

2. The locking device according to claim 1, wherein the positioning sleeve further includes a fourth stop convex part, the second stop convex part is located between the first stop convex part and the fourth stop convex part, the fourth stop convex part is configured to restrict a movement limit of the third stop convex part after the third stop convex part crosses over the second stop convex part.

3. The locking device according to claim 1, wherein an outer periphery of the fastening part is a non-circular surrounding shape.

4. The locking device according to claim 3, wherein the outer periphery of the fastening part has two sides parallel to each other, the outer periphery as a whole of the fastening part is polygonal.

5. The locking device according to claim 1, wherein an outer periphery of the third stop convex part has two opposite recesses, three recesses uniformly distributed around the outer periphery, or four recesses uniformly distributed around the outer periphery.

6. The locking device according to claim 1, wherein the positioning sleeve has a placement part corresponding to a shape of the fastening part at an outer periphery of the first opening.

7. The locking device according to claim 1, wherein the positioning sleeve further includes a fourth stop convex part, the second stop convex part is located between the first stop convex part and the fourth stop convex part, the locking mechanism including:
an operating barrel, having a sleeve part enclosing outside the positioning sleeve and a cap part that is connected to the sleeve part and relative to the fourth stop convex part, the sleeve part and the cap part also define a motion space for a telescopic motion of the positioning sleeve;
a locking piece, fixedly connected to the cap part and extending out of a second opening of the joint sleeve; and
a locking spring, located in the motion space and surrounding the locking piece, the locking spring abuts between the fourth stop convex part and the cap part.

8. The locking device according to claim 7, wherein the locking piece has an external thread, the operating barrel is configured to rotate relative to the positioning sleeve.

9. The locking device according to claim 7, wherein the locking mechanism further comprises a cap casing piece, the cap casing piece encloses and fixes to the outside of the sleeve part, and the cap casing piece has a texture for easy to hold.

10. The locking device according to claim 7, wherein an elastic force of the joint spring is greater than an elastic force of the locking spring.
